(19) United States
(12) Patent Application Publication
(10) Pub. No.: US 2026/0223074 A1
(43) Pub. Date: Jul. 30, 2026

(54) RESOURCE SELECTION ENHANCEMENT

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Giovanni CHISCI, San Diego, CA (US); Changlong XU, Beijing (CN); Shaozhen GUO, Beijing (CN); Luanxia YANG, Beijing (CN)

(21) Appl. No.: 19/146,148

(22) PCT Filed: Mar. 7, 2023
(86) PCT No.: PCT/CN2023/079991

§ 371 Date: Jul. 7, 2025

(51) Int. Cl. H04W 72/02; H04L 1/08; H04W 72/25

(52) U.S. Cl. CPC H04W 72/02; H04L 1/08; H04W 72/25

(57) ABSTRACT

Methods, systems, and devices for wireless communications are described. Prior to performing a listen before talk (LBT) procedure, a user equipment (UE) may perform a resource selection procedure to select a resource for transmission of a sidelink message and select multiple candidate resources from a resource pool. After resource selection procedure, the UE may perform the LBT procedure to gain access to a sidelink channel and transmit the first sidelink message via the selected resource. Further, the UE may transmit sidelink control information (SCI) associated with the first sidelink message, where the SCI includes an indication of a resource for feedback of the sidelink message and at least a first retransmission resource. In such examples, the UE may select the first retransmission resource from the multiple candidate resources based on a time gap between a time slot of the sidelink message and a time slot of the resource for feedback.

### CROSS REFERENCE

The present Application for Patent is a 371 national phase filing of International Patent Application No. PCT/CN2023/079991 by CHEN et al., entitled “RESOURCE SELECTION ENHANCEMENT,” filed Mar. 7, 2023, assigned to the assignee hereof, and expressly incorporated by reference herein.

### FIELD OF TECHNOLOGY

The following relates to wireless communications, including resource selection enhancement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support resource selection enhancement. For example, the described techniques provide for selecting resources for sidelink messages from multiple candidate resources after performing a listen before talk (LBT) procedure, which may result in reduced latency and more efficient utilization of communication resources. For example, prior to performing the LBT procedure, a user equipment (UE) may perform a resource selection procedure to select a resource for transmission of a sidelink message and select multiple candidate resources from a resource pool. Based on performing the resource selection procedure, the UE may perform the LBT procedure to gain access to a sidelink channel and transmit the first sidelink message via the selected resource. Further, the UE may transmit sidelink control information (SCI) associated with the first sidelink message, where the SCI includes an indication of a resource for feedback of the sidelink message and at least a first retransmission resource. In such examples, the UE may select the first retransmission resource from the multiple candidate resources based on a time gap between a time slot of the sidelink message and a time slot of the resource for feedback.

A method for wireless communications at a UE is described. The method may include transmitting or receiving a control message indicating a resource pool for sidelink communication, performing a resource selection procedure to select a resource for transmission of a first sidelink message and a set of multiple candidate resources from the resource pool, the set of multiple candidate resources being candidates for retransmission of the first sidelink message, transmitting, based on performing a LBT procedure to gain access to a sidelink channel of the resource pool, the first sidelink message during a first time slot via the resource for transmission of the first sidelink message, and transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

An apparatus for wireless communications at a UE is described. The apparatus may include a processor, memory coupled with the processor, and instructions stored in the memory. The instructions may be executable by the processor to cause the apparatus to transmit or receive a control message indicating a resource pool for sidelink communication, perform a resource selection procedure to select a resource for transmission of a first sidelink message and a set of multiple candidate resources from the resource pool, the set of multiple candidate resources being candidates for retransmission of the first sidelink message, transmit, based on performing a LBT procedure to gain access to a sidelink channel of the resource pool, the first sidelink message during a first time slot via the resource for transmission of the first sidelink message, and transmit first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

Another apparatus for wireless communications at a UE is described. The apparatus may include means for transmitting or receiving a control message indicating a resource pool for sidelink communication, means for performing a resource selection procedure to select a resource for transmission of a first sidelink message and a set of multiple candidate resources from the resource pool, the set of multiple candidate resources being candidates for retransmission of the first sidelink message, means for transmitting, based on performing a LBT procedure to gain access to a sidelink channel of the resource pool, the first sidelink message during a first time slot via the resource for transmission of the first sidelink message, and means for transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

A non-transitory computer-readable medium storing code for wireless communications at a UE is described. The code may include instructions executable by a processor to transmit or receive a control message indicating a resource pool for sidelink communication, perform a resource selection procedure to select a resource for transmission of a first sidelink message and a set of multiple candidate resources from the resource pool, the set of multiple candidate resources being candidates for retransmission of the first sidelink message, transmit, based on performing a LBT procedure to gain access to a sidelink channel of the resource pool, the first sidelink message during a first time slot via the resource for transmission of the first sidelink message, and transmit first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

Some examples of the method, apparatuses, and non-transitory computer-readable medium described herein may further include operations, features, means, or instructions for receiving a negative acknowledgement (NACK) via the resource for transmission of the feedback of the first sidelink message and transmitting, via the first retransmission resource, a retransmission of the first sidelink message and second SCI.

In some examples of the method, apparatuses, and non-transitory computer-readable medium described herein, the first SCI indicates a slot of a second retransmission resource for retransmission of the first sidelink message and the second SCI indicates a second resource for feedback for the retransmission of the first sidelink message, the second resource for feedback for the retransmission of the first sidelink message being based on a second time gap between a time slot associated with the first retransmission resource and the time slot of the second retransmission resource for retransmission of the first sidelink message.

In some examples of the method, apparatuses, and non-transitory computer-readable medium described herein, transmitting the first SCI may include operations, features, means, or instructions for transmitting, via the first SCI, an indication of a second retransmission resource for a second retransmission of the first sidelink message, the second retransmission resource being different from the first retransmission resource.

In some examples of the method, apparatuses, and non-transitory computer-readable medium described herein, the first retransmission resource and the second retransmission resource may be selected after performing the LBT procedure.

In some examples of the method, apparatuses, and non-transitory computer-readable medium described herein, the first SCI may be transmitted in the first time slot based on the LBT procedure indicating that the sidelink channel may be available prior to the first time slot.

Some examples of the method, apparatuses, and non-transitory computer-readable medium described herein may further include operations, features, means, or instructions for dropping second SCI based on the LBT procedure indicating that the sidelink channel may be unavailable during a second time slot that occurs prior to the first time slot and generating the first SCI based on the LBT procedure indicating that the sidelink channel may be available during the first time slot.

In some examples of the method, apparatuses, and non-transitory computer-readable medium described herein, the resource selection procedure corresponds to resource selection within a time duration of sixty-four slots.

In some examples of the method, apparatuses, and non-transitory computer-readable medium described herein, a quantity of bits in a resource reservation field of the first SCI associated with reserving resources for one or more retransmissions of the first sidelink message may be based on a quantity of resources reserved for retransmission of the first sidelink message.

A method for wireless communications at a UE is described. The method may include transmitting or receiving a control message indicating a resource pool for sidelink communication, receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message, and monitoring, based on the SCI, for the first sidelink message during the first time slot via the resource for transmission of the first sidelink message.

An apparatus for wireless communications at a UE is described. The apparatus may include a processor, memory coupled with the processor, and instructions stored in the memory. The instructions may be executable by the processor to cause the apparatus to transmit or receive a control message indicating a resource pool for sidelink communication, receive SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message, and monitor, based on the SCI, for the first sidelink message during the first time slot via the resource for transmission of the first sidelink message.

Another apparatus for wireless communications at a UE is described. The apparatus may include means for transmitting or receiving a control message indicating a resource pool for sidelink communication, means for receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message, and means for monitoring, based on the SCI, for the first sidelink message during the first time slot via the resource for transmission of the first sidelink message.

A non-transitory computer-readable medium storing code for wireless communications at a UE is described. The code may include instructions executable by a processor to transmit or receive a control message indicating a resource pool for sidelink communication, receive SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message, and monitor, based on the SCI, for the first sidelink message during the first time slot via the resource for transmission of the first sidelink message.

Some examples of the method, apparatuses, and non-transitory computer-readable medium described herein may further include operations, features, means, or instructions for transmitting a NACK via the resource for transmission of the feedback of the first sidelink message and receiving, via the first retransmission resource, a retransmission of the first sidelink message and second SCI.

In some examples of the method, apparatuses, and non-transitory computer-readable medium described herein, the SCI indicates a slot of a second retransmission resource for retransmission of the first sidelink message and the second SCI indicates a second resource for feedback for the retransmission of the first sidelink message, the second resource for feedback for the retransmission of the first sidelink message being based on a second time gap between a time slot associated with the first retransmission resource and the time slot of the second retransmission resource for retransmission of the first sidelink message.

In some examples of the method, apparatuses, and non-transitory computer-readable medium described herein, receiving the SCI may include operations, features, means, or instructions for receiving, via the SCI, an indication of a second retransmission resource for a second retransmission of the first sidelink message, the second retransmission resource being different from the first retransmission resource.

In some examples of the method, apparatuses, and non-transitory computer-readable medium described herein, the SCI may be received in the first time slot.

In some examples of the method, apparatuses, and non-transitory computer-readable medium described herein, the set of multiple candidate resources may be within a time duration of sixty-four slots.

In some examples of the method, apparatuses, and non-transitory computer-readable medium described herein, a quantity of bits in a resource reservation field of the SCI associated with reserving resources for one or more retransmissions of the first sidelink message may be based on a quantity of resources reserved for retransmission of the first sidelink message.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a quantity of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports resource selection enhancement in accordance with one or more aspects of the present disclosure.

FIG. 2 illustrates an example of a network architecture that supports resource selection enhancement in accordance with one or more aspects of the present disclosure.

FIG. 3 illustrates an example of a wireless communications that supports resource selection enhancement in accordance with one or more aspects of the present disclosure.

FIG. 4 illustrates an example of a timing diagram that supports resource selection enhancement in accordance with one or more aspects of the present disclosure.

FIG. 5 illustrates an example of a process flow that supports resource selection enhancement in accordance with one or more aspects of the present disclosure.

FIGS. 6 and 7 illustrate block diagrams of devices that support resource selection enhancement in accordance with one or more aspects of the present disclosure.

FIG. 8 illustrates a block diagram of a communications manager that supports resource selection enhancement in accordance with one or more aspects of the present disclosure.

FIG. 9 illustrates a diagram of a system including a device that supports resource selection enhancement in accordance with one or more aspects of the present disclosure.

FIGS. 10 through 13 illustrate flowcharts showing methods that support resource selection enhancement in accordance with one or more aspects of the present disclosure.

### DETAILED DESCRIPTION

In some wireless communications systems, a first user equipment (UE) and a second UE may communicate via resources in a sidelink channel. For example, the first UE may transmit, to the second UE, a message reserving a resource for transmission of a sidelink message and reserving two or more retransmission resources for the sidelink message. In such examples, the first UE may reserve each resource (e.g., the resource for initial transmission and two or more retransmission resources) from a resource pool based on a minimum time gap between each resource, such that the first UE may be able to receive and process hybrid automatic repeat request (HARQ) feedback from the second UE in the time between the transmission resources. For example, the first UE may select a first resource for an initial transmission of the sidelink message and select a second resource for retransmission of the sidelink message, where the time between the time slots of the first and second resources satisfies the minimum time gap. As such, if the second UE transmits HARQ feedback to the first UE, the first UE may have enough time (e.g., due to the minimum time gap between resources) to receive and process the HARQ feedback prior to the occasion of the retransmission resource.

In response to indicating the reserved resources, the first UE may perform a listen before talk (LBT) procedure to gain access to the sidelink channel. The LBT procedure may involve the first UE performing an energy sensing operation to determine if energy is detected from any other device that is transmitting in a particular time and frequency resource. If the detected energy falls below a threshold, the first UE determine that the channel is available and may be used for transmission. If the LBT procedure indicates that the particular time and frequency resource is busy, the first UE skips transmitting in that resource and attempts to find a different particular time and frequency resource that is available for transmission. In some cases, after gaining access to the sidelink channel, the first UE may dynamically indicate one or more resources for HARQ feedback to the second UE. In such cases, however, if the one or more resources for HARQ feedback are dynamically indicated after the resource reservation procedure, there may not be enough time between the one or more resources for HARQ feedback and the previously selected resources for retransmission of the sidelink message. As such, in cases of dynamic HARQ timelines (e.g., dynamically indicating HARQ resources after resource selection), the first UE may reserve resources based on a conservative time gap prediction, thereby leading to increased latency in the wireless communications system.

The techniques, methods, and devices described herein may enable the first UE to select up to two retransmission resources from multiple candidate resources after performing the LBT procedure, thereby enabling the first UE to efficiently select retransmission resources in cases of dynamically indicated HARQ resources. For example, prior to performing the LBT procedure, the first UE may perform a selection procedure to select a resource for the initial transmission of the sidelink message and select one or more candidate resources for retransmission of the sidelink message. Based on performing the LBT procedure, the first UE may transmit the sidelink message in a first time slot associated with the resource for the initial transmission.

Further, the first UE may transmit sidelink control information (SCI) associated with the sidelink message, where the SCI indicates a retransmission resource for the sidelink message and a resource for HARQ feedback of the sidelink message. In such examples, the first UE may select the retransmission resource from the identified candidate resources based on a time gap (e.g., K1 value) between the first time slot of the initial sidelink message and a time slot of the resource for HARQ feedback. In this way, the first UE may be able to consider time slots associated with the dynamically indicated resource for HARQ feedback when selecting resources for retransmission of the sidelink message, thereby reducing latency associated with conservative time gap predictions in dynamic HARQ timelines.

Aspects of the disclosure are initially described in the context of wireless communications systems. Aspects of the disclosure are further described in the context of a timing diagram and process flow. Aspects of the disclosure are further illustrated by and described with reference to apparatus diagrams, system diagrams, and flowcharts that relate to resource selection enhancement.

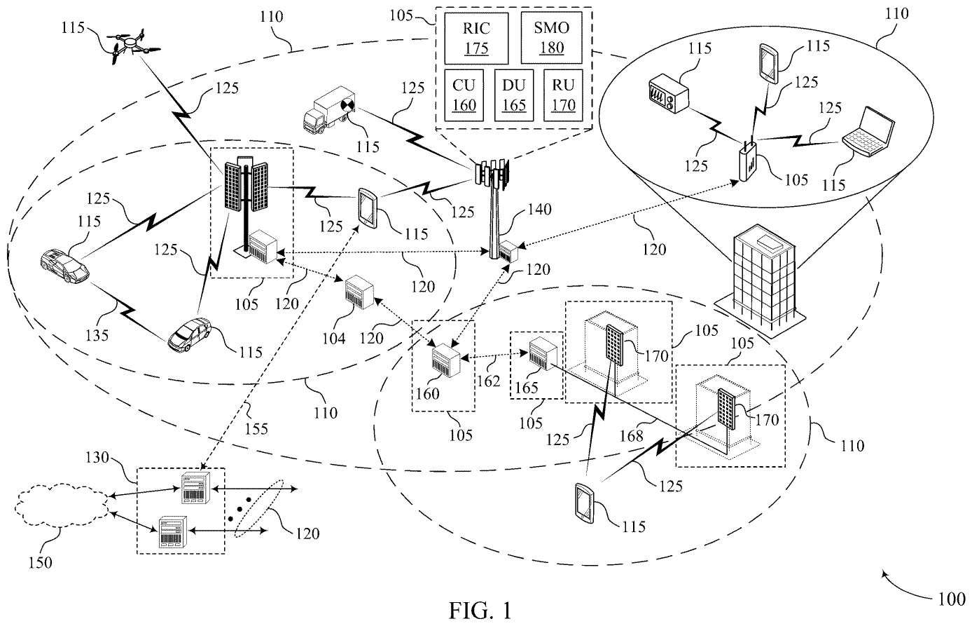

FIG. 1 illustrates an example of a wireless communications system 100 that supports resource selection enhancement in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource selection enhancement as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a first UE 115 and a second UE 115 may communicate via resources in a sidelink channel. For example, the first UE 115 may transmit, to the second UE 115, a message reserving a resource for transmission of a sidelink message and reserving two or more retransmission resources for the sidelink message. In such examples, the first UE 115 may reserve each resource (e.g., the resource for initial transmission and the two or more retransmission resources) from a resource pool based on a minimum time gap between each resource, such that the first UE 115 may be able to receive and process HARQ feedback from the second UE 115 in the time between the transmission resources. For example, the first UE 115 may select a first resource for an initial transmission of the sidelink message and select a second resource for retransmission of the sidelink message, where the time between the time slots of the first and second resources satisfies the minimum time gap. As such, if the second UE 115 transmits HARQ feedback to the first UE 115, the first UE 115 may have enough time (e.g., due to the minimum time gap between resources) to receive and process the HARQ feedback prior to the occasion of the retransmission resource.

In response to indicating the reserved resources, the first UE 115 may perform a LBT procedure to gain access to the sidelink channel. In some cases, after gaining access to the sidelink channel, the first UE 115 may dynamically indicate one or more resources for HARQ feedback to the second UE 115, such that the second UE 115 may use such resources for the transmission of HARQ feedback for the sidelink message. In such cases, however, if the one or more resources for HARQ feedback are dynamically indicated after the resource reservation procedure, there may not be a enough time between the one or more resources for HARQ feedback and the previously selected resources for retransmission of the sidelink message. As such, in cases of dynamic HARQ timelines (e.g., dynamically indicating HARQ resources after resource selection), the first UE 115 may reserve resources based on a conservative time gap prediction, thereby leading to increased latency in the wireless communications system.

The techniques, methods, and devices described herein may enable the first UE 115 to select two or more retransmission resources from multiple candidate resources after performing the LBT procedure, thereby enabling the first UE 115 to efficiently select retransmission resources in cases of dynamically indicated HARQ resources. For example, prior to performing the LBT procedure, the first UE 115 may perform a selection procedure to select a resource for the initial transmission of the sidelink message and select one or more candidate resources for retransmission of the sidelink message. The first UE 115 may perform the LBT procedure to gain access to the sidelink channel. Based on performing the LBT procedure, the first UE 115 may transmit the sidelink message in a first time slot associated with the resource for the initial transmission. Further, the first UE 115 may transmit SCI associated with the sidelink message, where the SCI indicates a retransmission resource for the sidelink message and a resource for HARQ feedback of the sidelink message. In such examples, the first UE 115 may select the retransmission resource from the identified candidate resources based on a time gap (e.g., K1 value) between the first time slot of the initial transmission and a time slot of the resource for HARQ feedback. In this way, the first UE 115 may be able to consider the time slots of the dynamically indicated resource for HARQ feedback when selecting resources for retransmission of the sidelink message, thereby reducing latency associated with conservative time gap predictions in dynamic HARQ timelines.

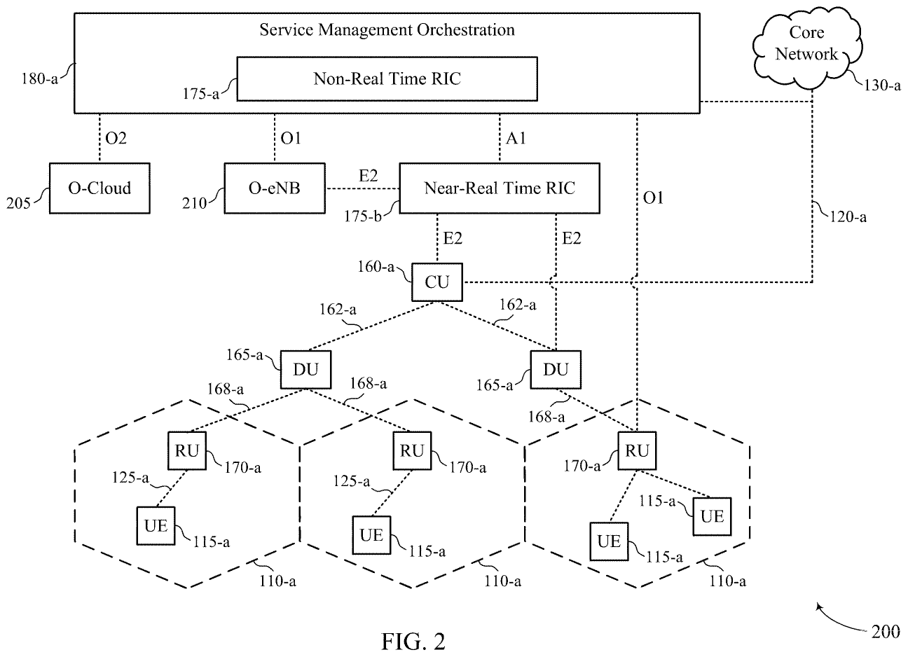

FIG. 2 illustrates an example of a network architecture 200 (e.g., a disaggregated base station architecture, a disaggregated RAN architecture) that supports resource selection enhancement in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some cases, a first UE 115-a and a second UE 115-a may communicate via resources in a sidelink channel. For example, the first UE 115-a may transmit, to the second UE 115-a, a message reserving a resource for transmission of a sidelink message and reserving two or more retransmission resources for the sidelink message. In such examples, the first UE 115-a may reserve each resource (e.g., the resource for initial transmission and two or more retransmission resources) from a resource pool based on a minimum time gap between each resource, such that the first UE 115-a may be able to receive and process HARQ feedback from the second UE 115-a in the time between the transmission resources. For example, the first UE 115-a may select a first resource for an initial transmission of the sidelink message and select a second resource for retransmission of the sidelink message, where the time between the time slots of the first and second resources satisfies the minimum time gap. As such, if the second UE 115-a transmits HARQ feedback to the first UE 115-a, the first UE 115-a may have enough time (e.g., due to the minimum time gap between resources) to receive and process the HARQ feedback prior to the occasion of the retransmission resource.

In response to indicating the reserved resources, the first UE 115-a may perform a LBT procedure to gain access to the sidelink channel. In some cases, after gaining access to the sidelink channel, the first UE 115-a may dynamically indicate one or more resources for HARQ feedback to the second UE 115-a, such that the second UE 115-a may use such resources for the transmission of HARQ feedback for the sidelink message. In such cases, however, if the one or more resources for HARQ feedback are dynamically indicated after the resource reservation procedure, there may not be a enough time between the one or more resources for HARQ feedback and the previously selected resources for retransmission of the sidelink message. As such, in cases of dynamic HARQ timelines (e.g., dynamically indicating HARQ resources after resource selection), the first UE 115-a may reserve resources based on a conservative time gap prediction, thereby leading to increased latency in the wireless communications system.

The techniques, methods, and devices described herein may enable the first UE 115-a to select two or more retransmission resources from multiple candidate resources after performing the LBT procedure, thereby enabling the first UE 115-a to efficiently select retransmission resources in cases of dynamically indicated HARQ resources. For example, prior to performing the LBT procedure, the first UE 115-a may perform a selection procedure to select a resource for the initial transmission of the sidelink message and select one or more candidate resources for retransmission of the sidelink message. The first UE 115-a may perform the LBT procedure to gain access to the sidelink channel. Based on performing the LBT procedure, the first UE 115-a may transmit the sidelink message in a first time slot associated with the resource for the initial transmission. Further, the first UE 115-a may transmit SCI associated with the sidelink message, where the SCI indicates a retransmission resource for the sidelink message and a resource for HARQ feedback of the sidelink message. In such examples, the first UE 115-a may select the retransmission resource from the identified candidate resources based on a time gap (e.g., K1 value) between the first time slot of the initial transmission and a time slot of the resource for HARQ feedback. In this way, the first UE 115-a may be able to consider the time slots of the dynamically indicated resource for HARQ feedback when selecting resources for retransmission of the sidelink message, thereby reducing latency associated with conservative time gap predictions in dynamic HARQ timelines.

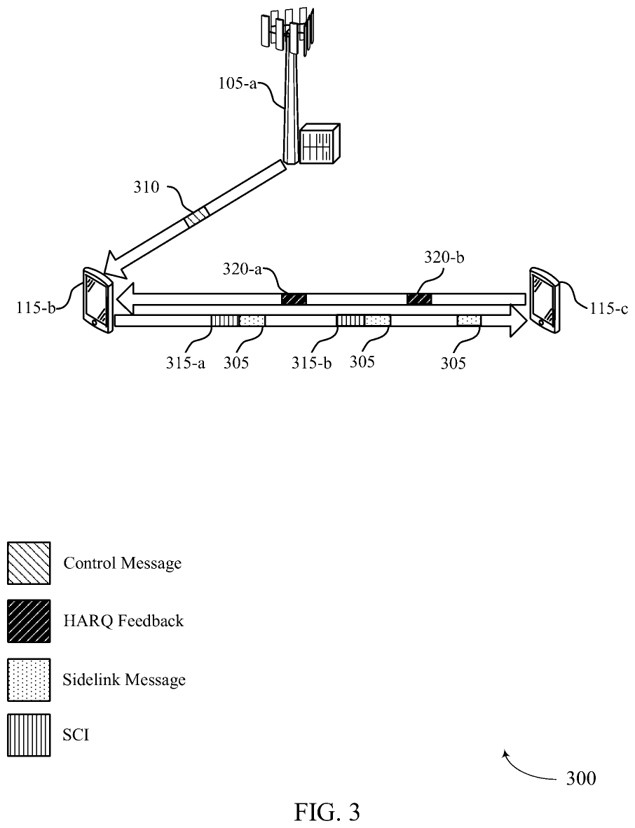

FIG. 3 illustrates an example of a wireless communications system 300 that supports resource selection enhancement in accordance with one or more aspects of the present disclosure. The wireless communications system 300 may implement or be implemented by aspects of wireless communications system 100 and the network architecture 200 with reference to FIGS. 1 and 2. For example, the wireless communications system 300 may include a network entity 105-a, a UE 115-b, and a UE 115-c, which may be examples of corresponding UEs 115 and network entities 105 as described herein. The wireless communications system 300 may implement techniques for selecting retransmission resources for sidelink messages after performing an LBT procedure.

In some cases, the UE 115-b and the UE 115-c may communicate one or more sidelink messages 305 via various resources in a resource pool according to a sidelink mode of operation (e.g., sidelink mode 1 or sidelink mode 2). In a first mode of sidelink operation (e.g., sidelink mode 1), the network entity 105-a may transmit a control message 310 (e.g., such as downlink control information (DCI)) to the UE 115-b indicating a resource pool (e.g., one or more time and frequency resources) for use in sidelink communications. Additionally, the network entity 105-a may indicate one or more communication parameters for sidelink operations, such as indicating the performance of the LBT procedure, a quantity of resources that may be reserved, or the like. As such, the UE 115-b may select a resource for the initial transmission of a sidelink message 305 and may further select two or more resources from the resource pool to be used for retransmissions of the sidelink message 305.

In a second mode of sidelink operation (e.g., sidelink mode 2), the UE 115-b (e.g., the transmitting UE) may autonomously determine a resource pool and select resources from the resource pool for the transmission and retransmission of the initial sidelink message 305. In such examples, the UE 115-b may autonomously select a resource from the resource pool for transmission of the sidelink message 305 and two or more resources for retransmission of the sidelink message 305. In such examples, the UE 115-b may transmit an indication of the selected resources to the UE 115-c via the SCI 315-a, where the UE 115-c may perform blind detection to receive the SCI 315-a. In this way, the UE 115-c may monitor for and receive the sidelink message 305.

In some cases, in either sidelink mode, the UE 115-b (e.g., transmitting UE) may select, from the resource pool during a resource selection procedure, the resource for the initial transmission of the sidelink message 305 and two or more retransmission resources in accordance with a defined (e.g., minimum) time gap (e.g., tGAP). In some examples, the resource selection procedure may involve the UE 115-b picking one or more time-frequency resources from a resource pool within a sliding time window, also referred to herein as a selection window, for transmitting an initial transmission of a sidelink message and one or more retransmissions of the sidelink message. That is, for resource selection, there be a defined (e.g., minimum) time gap (e.g., represented in a quantity of slots) between any pair of consecutively selected retransmission resources (e.g., HARQ retransmissions), such that the UE 115-b (e.g., transmitting UE) may receive and process the HARQ feedback 320 (e.g., acknowledgments (ACK) or negative ACK (NACK)) from the UE 115-c (e.g., receiving UE), and prepare the next occasion of the sidelink message 305 (e.g., the HARQ retransmission of the sidelink message 305).

For example, the UE 115-b may select a first resource for an initial transmission of the sidelink message 305 and select a second resource for retransmission of the sidelink message 305, where the time or quantity of time slots between the time slots of the first and second resources satisfies the minimum time gap (e.g., tGAP). As such, if the UE 115-c transmits HARQ feedback 320 to the UE 115-b, the UE 115-b may have enough time (e.g., due to the minimum time gap between resources) to receive and process the HARQ feedback 320 prior to the occasion of the retransmission resource.

In order to indicate the selected resources in the time domain, the UE 115-b may transmit an SCI 315 that includes a time resource indication value (TRIV). For example, a time resource assignment (e.g., indication of resources) may include (e.g., carry) a logical slot offset indication N, where N may be equal to ‘1’ or ‘2’ (e.g., N=1 or 2) resources when a maximum quantity of reserved resources (e.g., sl-MaxNumPerReserve) is configured to be two. Alternatively, N may be equal to ‘1’, ‘2’, or ‘3’ (e.g., N=1 or 2 or 3) resources when the maximum quantity of reserved resources (e.g., sl-MaxNumPerReserve) is configured to be three. In such examples, the time resource assignment may be indicated, or represented, in the form of the TRIV field of the SCI 315. The UE 115-b may determine the TRIV in accordance with the following pseudocode:

```
if N = 1
      TRIV = 0
elseif N = 2
      TRIV = t₁
else
  if (t₂ − t₁ − 1) ≤ 15
    TRIV = 30(t₂ − t₁ − 1) + t₁
        + 31
  else
    TRIV = 30(31 − t₂ + t₁) + 62
        − t₁
  end if
end if
```

Where the first resource of the sidelink message 305 may be associated with the slot that the SCI 315 (e.g., SCI format 1-A) was received at the UE 115-c, and tᵢ denotes i-th resource time offset that is represented in logical slots of the resource pool with respect to the first resource, where for N=2, 1≤t₁≤31; and for N=3, 1≤t≤30, t₁≤t₂≤31.

That is, the UE 115-b may transmit the SCI 315-a and the sidelink message 305 in a first time slot (e.g., where the SCI 315-a may be located in the first time slot before at least a portion of the sidelink message 305), where the UE 115-b may indicate, via the SCI 315-a, the TRIVs for the initial transmission of the sidelink message 305 and the retransmissions of the sidelink message 305. As such, the UE 115-b may determine the TRIV based on the logical offset value N, where N is based on the maximum quantity of reserved resources (e.g., sl-MaxNumPerReserve). As such, based on the TRIV value, the UE 115-c may identify the resources to be used for the sidelink message 305 and the resources used for the retransmissions of the sidelink message 305, where each resource may be separated by a quantity of time slots in accordance with the minimum time gap.

In some cases, the UE 115-c may transmit, to the UE 115-b, HARQ feedback 320-a for the initial sidelink message 305 via resources of a physical sidelink feedback channel (PSFCH). For example, the UE 115-c may monitor the indicated resources for the initial transmission of the sidelink message 305. In some cases, the UE 115-c may successfully detect, decode, and receive the sidelink message 305. In some other cases, the UE 115-c may not detect, or otherwise successfully decode, the sidelink message 305. In either case, the UE 115-c may perform a LBT procedure to gain access to the PSFCH and transmit the HARQ feedback 320-a for the initial sidelink message 305. In some cases, however, the UE 115-c may perform the LBT procedure and determine that the UE 115-c may not access the PSFCH (e.g., the LBT procedure failed or indicated that the PSFCH is busy). In such cases, the UE 115-c may drop the transmission of the HARQ feedback 320-a.

To address dropping the PSFCH transmission (e.g., HARQ feedback 320-a) due to LBT failure, the UE 115-b and the UE 115-c may implement a dynamic HARQ timeline. For example, the UE 115-b and the UE 115-c may support more than a single PSFCH occasion per physical sidelink control channel (PSCCH) transmission (e.g., transmission of the sidelink message 305), per physical sidelink shared channel (PSSCH) transmissions (e.g., transmission of the SCI 315), or both. The UE 115-b and the UE 115-c may implement various HARQ-ACK timelines accordingly. In some other examples, the UE 115-b and the UE 115-c may implement dynamic indications for PSFCH occasions.

In such examples, the UE 115-b and the UE 115-c may implement techniques to handle the case where some transmission blocks (TBs) corresponding to the PSFCH may not be able to be transmitted within the same, or different, channel occupancy time (COT). Further, the UE 115-b and the UE 115-c may implement one or more techniques or signaling for dynamically indicating one or more PSFCH transmissions, container of the indication (e.g., what signaling indicates the dynamic PSFCH transmissions), or the like. Further, the UE 115-b and the UE 115-c may implement one or more techniques to handle cases when PSFCH occasions are within the same COT, different COTs, of a corresponding PSSCH, to handle potential PSFCH collisions, to handle linearly decreased PSFCH capacity, or the like.

In one example of such techniques, the UE 115-b may dynamically indicate the resources (e.g., PFSCH resources) for the HARQ feedback 320 after successful completion of the LBT. For example, when the UE 115-b successfully completes the LBT and initiates a COT of the sidelink channel (e.g., PSSCH, PSCCH, or both), the UE 115-b may indicate, to the UE 115-c, where the PSFCH resources are within the COT. That is, the UE 115-b may indicate the time slots associated with the PSFCH resources for the HARQ feedback 320. Further, in order to transmit a message via various time slots (e.g., a long burst), the UE 115-b may defer the transmission of the HARQ feedback 320 (e.g., the ACK or NACK) to the end of burst to avoid switching between transmitting and receiving in PSFCH symbols.

In some examples, in order to indicate the occasions of the PSFCH resources for the HARQ feedback 320 after completion of the LBT, each PSFCH transmission occasion may be configured prior to the completion of the LBT (e.g., in accordance with legacy NR sidelink communications). In such examples, the UE 115-b may dynamically indicate a time gap between the PSSCH and PSFCH. In some other examples, the UE 115-b may dynamically indicate the PSFCH transmission occasions (e.g., the PSFCH occasions are not pre-configured).

When implementing the dynamic HARQ timeline, the UE 115-b and the UE 115-c may experience an impact on the resource selection procedure for the sidelink message 305. For example, using current techniques (e.g., in legacy resource selection procedure), the UE 115-b may select two adjacent resources for the transmission of the sidelink message. As such, a gap between the two adjacent resources may be larger than z=a+b, where z represents the time gap and considers the time of receiving and processing the HARQ feedback 320 from the UE 115-b (e.g., a) and the preparation time for the retransmission of the sidelink message 305 (e.g., b). However, if the resource of the PSFCH is dynamically indicated, the gap between PSSCH resource and associated PSFCH resource may be variable and may not be available during resource selection procedure. As such, the UE 115-b may provision enough of a gap to meet the minimum time gap. In such cases, the conservative predication of the time gap may increase the latency of the wireless communications system 300.

For example, if the one or more resources for HARQ feedback 320 are dynamically indicated after the resource selection procedure, there may not be a enough time between the one or more resources for HARQ feedback 320 and the previously selected resources for retransmission of the sidelink message 305. As such, in cases of dynamic HARQ timelines (e.g., dynamically indicating HARQ resources after resource selection), the UE 115-b may reserve resources based on a conservative time gap prediction, thereby leading to increased latency in the wireless communications system.

The techniques, methods, and devices described herein may enable the UE 115-b to efficiently select retransmission resources for the sidelink message 305. For example, the UE 115-b (e.g., transmitting UE) may autonomously determine a resource pool for sidelink communication while operating in the second sidelink mode. Alternatively, the UE 115-b may receive, from the network entity 105-a via the control message 310 (e.g., such as DCI format 3_0) while operating in the first sidelink mode, an indication of the resource pool for the sidelink communications.

Prior to performing an LBT procedure to gain access to the sidelink channel (e.g., PSSCH), the UE 115-b may perform a resource selection procedure to select a first resource for transmission of the sidelink message 305 (e.g., the first sidelink message 305) from the resource pool. Further, the UE 115-b may select, during the resource selection procedure, multiple candidate resources for retransmission of the sidelink message 305.

In response to performing the resource selection procedure and performing the LBT procedure, the UE 115-b may transmit the sidelink message 305 during a first time slot via the first resource. In such examples, the UE 115-b may transmit the sidelink message 305 via a PSSCH or PSFCH.

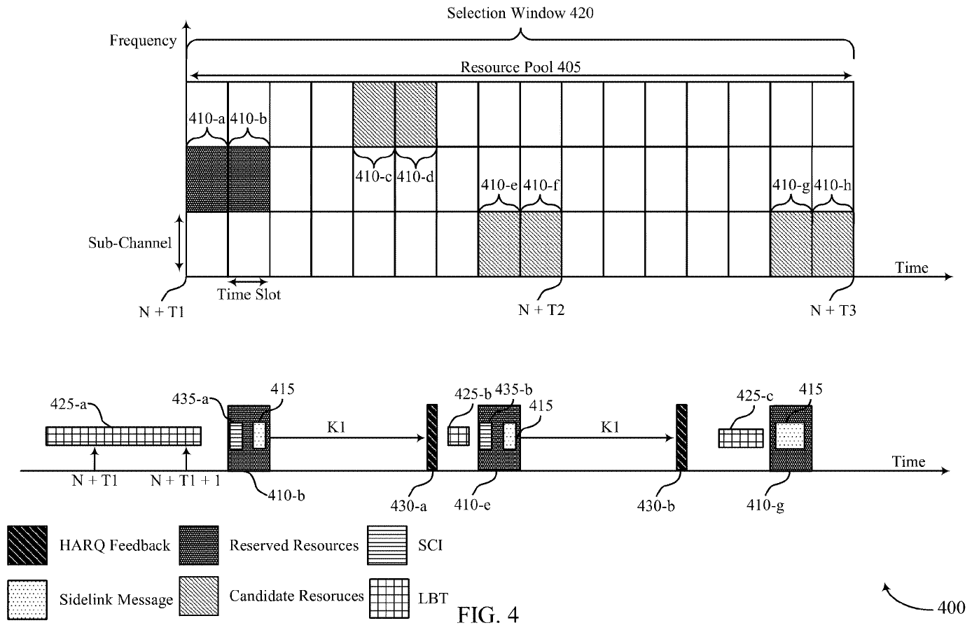

Further, the UE 115-b may transmit, during the first time slot associated with a resource via a PSFCH, the SCI 315-a (e.g., first SCI 315-a), which is associated with the initial sidelink message 305. The UE 115-b may indicate, via the SCI 315-a, a resource for HARQ feedback 320-a for the initial sidelink message 305, a first retransmission resource for the sidelink message 305, a second retransmission resource for the sidelink message 305, or a combination thereof. In such examples, the UE 115-b may select the first retransmission resource for the sidelink message 305 from the multiple candidate resources based on a first time gap between the first time slot of the sidelink message 305 and a time slot of the resource for HARQ feedback 320-a. Such selection techniques may be further described herein with reference to FIG. 4. Further, the SCI 315-a may indicate the first resource associated with the initial sidelink message 305.

By selecting the first resource for retransmission of the sidelink message after performing the LBT, the UE 115-b may ensure that the consecutively selected resources are selected in accordance with the minimum time gap and that the UE 115-b may have enough time to receive and process the HARQ feedback 320-a and prepare for a first retransmission of the sidelink message 305.

In response to receiving the SCI 315-a via the PSCCH, the UE 115-c may monitor the first resource during the first time slot for the initial sidelink message 305. In some examples, the UE 115-c may not receive the initial transmission of the sidelink message 305. As such, the UE 115-c may transmit, via the indicated resource for the HARQ feedback 320-a, the HARQ feedback 320-a indicating a NACK for the initial sidelink message 305.

In response to receiving the NACK as a part of the HARQ feedback 320-a, the UE 115-b may transmit, via the first retransmission resource, a SCI 315-b (e.g., a second SCI) and a first retransmission of the sidelink message 305 (e.g., where the SCI 315-b may be located in a time slot before at least a portion of the retransmission of the sidelink message 305). In such examples, the UE 115-b may indicate, via the SCI 315-b, a second resource for HARQ feedback 320-b, where the HARQ feedback 320-b is associated with the first retransmission of the sidelink message 305. In such examples, the UE 115-b may select the resource for the HARQ feedback 320-b based on a second time gap between a time slot associated with the first retransmission resource and a time slot associated with the second retransmission resource. In this way, the UE 115-b may determine a resource for the HARQ feedback 320-b, such that the UE 115-b may have time to receive the HARQ feedback 320-b, process the message, and prepare the occasion of the second retransmission of the sidelink message 305.

In response to receiving the SCI 315-b via a resource of the PSCCH, the UE 115-c may monitor the first retransmission resource for the first retransmission of the sidelink message 305. In some examples, the UE 115-c may not receive the first retransmission of the sidelink message 305. As such, the UE 115-c may transmit, via the second resource for the HARQ feedback 320-b, the HARQ feedback 320-b indicating a NACK for the first retransmission of the sidelink message 305.

In response to receiving the NACK as part of the HARQ feedback 320-b, the UE 115-b may transmit, via the second retransmission resource, the second retransmission of the sidelink message 305. The UE 115-c may monitor the second retransmission resource for the second retransmission of the sidelink message 305 accordingly.

In some examples, due to the dynamic indication of resources for the HARQ feedback 320, the UE 115-b may reserve resources for the retransmission of the sidelink message 305 within 64 slots of the resource pool. For example, the UE 115-b may receive at indication of (e.g., via in control signaling from a network entity), or autonomously determine, the resource pool for sidelink communications. As such, the UE 115-b may determine candidate resources for retransmission of the sidelink message 305 that meet the minimum time gap (e.g., perform the selection procedure) from within a selection window that spans 64 time slots of the resource pool.

By implementing the techniques described herein, the UE 115-b may select two or more retransmission resources for the sidelink message according to a minimum time gap and maintain time between resources for HARQ feedback 320 in dynamic HARQ timelines, which may reduce latency and improve efficiency in the wireless communications system 300.

FIG. 4 illustrates an example of a timing diagram 400 that supports resource selection enhancement in accordance with one or more aspects of the present disclosure. Aspects of the timing diagram may be implemented by the wireless communications system 100, the network architecture 200, and the wireless communications system 300 as described herein with reference to FIGS. 1 through 3. For example, aspects of the timing diagram 400 may be implemented by one or more UE s115, which may be an example of a UE 115-b (e.g., transmitting UE 115) or a UE 115-c (e.g., receiving UE 115) as described herein with reference to FIG. 3. The timing diagram 400 may include a resource pool 405 from which the UE 115 may select one or more resources 410 for transmission and retransmission of a sidelink message 415 in a dynamic HARQ timeline. As an illustrative example of the timing diagram 400, each resource 410 of the resource pool 405 may span a sub-channel and a single time slot.

In accordance with the techniques described herein, the UE 115 (e.g., transmitting UE 115) may select, from the resource pool 405, candidate resources 410 (e.g., a batch of available resources) as part of a resource selection procedure prior to performing a LBT procedure 425. Further, the UE 115-b may determine resources for retransmission of the sidelink message 415 (e.g., which are to be indicated in an SCI 435-a) from the selected candidate resources 410 after performing a successful LBT 425-a in order to account for dynamic indications of resources for HARQ feedback 430.

In some examples, the UE 115 may reserve a single resource 410 for retransmission of the sidelink message 415. For example, prior to performing the LBT 425-a, the UE 115 may perform a resource selection procedure. In the resource selection procedure, the UE 115 may select one or more resources 410 as the candidate resources 410. Further, as part of the resource selection procedure, the UE 115 may select a resource 410 (e.g., first resource 410) for the initial transmission of the sidelink message 415.

That is, prior to performing the LBT 425-a to gain access to a sidelink channel, the UE 115 may perform the resource selection procedure to select a resource 410-b for the initial transmission of the sidelink message 415 and select one or more resources 410 as the candidate resources 410 (e.g., such as a resource 410-c, a resource 410-d, a resource 410-e, a resource 410-f, a resource 410-g, a resource 410-h). Based on performing the resource selection procedure, the UE 115 may perform the LBT 425-a to gain access to the sidelink channel.

When the UE 115 passes the LBT 425-a (e.g., the UE 115 gains access to the sidelink channel), the UE 115 may have an indication of a time gap (e.g., shown as K1) between a time slot of the resource 410-b for the initial transmission of the sidelink message 415 and a time slot of a resource for HARQ feedback 430-a for the sidelink message 415 (e.g., the UE 115 may receive a dynamic indication of in which time slot a resource 410 for the HARQ feedback 430-a is to occur). As such, the UE 115 may select, from the candidate resources 410, the resource 410-e (e.g., the first retransmission resource) for the retransmission of the sidelink message 415 based on the K1 value and indicate the resource 410-e via the SCI 435-a (e.g., SCI-1). Thus, the UE 115 may select the resource 410-e based on the K1 value, which may be an accurate prediction, thereby having less of an impact on latency.

That is, in the example of dynamic HARQ timelines, the UE 115 may have an indication of the time slot of the resource for the HARQ feedback 430-a after performing the LBT 425-a. As such, based on having the indication of the time slot of the resource for the HARQ feedback 430-a, the UE 115 may also have an indication of the time gap (e.g., K1 value) between the time slot of the resource 410-b and the time slot of the resource for the HARQ feedback 430-a. Thus, the UE 115 may select the resource 410-e based on the K1 value in order to maintain the minimum time gap between the resource 410-b and the resource 410-e and maintain enough time between the resource for the HARQ feedback 430-a and the resource 410-e.

For example, the UE 115 may not select the resource 410-c and the resource 410-d for the retransmission of the sidelink message 415 because the resource for the HARQ feedback 430-a occurs after the slots of the resource 410-c and the resource 410-d. Thus, the UE 115 may not select resources 410 for the retransmission of the sidelink message 415 from the candidate resources 410 that occur before, or in the same slot, as the resource for HARQ feedback 430-a, as the receiving UE may not have enough time to generate a NACK and transmit the NACK via the resource for HARQ feedback 430-a.

The UE 115 may transmit, via the resource 410-b, the initial sidelink message 415 and SCI 435-a (e.g., where the SCI 435-a may be located in a time slot before at least a portion of or an entirety of the sidelink message 415), where the SCI 435-a includes an indication of the resource 410-e for retransmission of the sidelink message and an indication of the resource for the HARQ feedback 430-a. If the UE 115 receives, via the resource for the HARQ feedback 430-a, a NACK as part of the HARQ feedback 430-a, the UE 115 may retransmit the sidelink message 415 via the resource 410-e. In this way, the UE 115 may select and indicate the resource 410-e from candidate resources 410 after performing the initial LBT 425-a, thereby enabling the UE 115 to accurately predict the time gap between the resource 410-b (e.g., used for the initial transmission of the sidelink message 415) and the resource 410-e (e.g., used for the retransmission of the sidelink message 415) in dynamic HARQ timelines.

In some examples, during the resource selection procedure, the UE 115 may select a resource 410-a for the initial transmission of the sidelink message 415. However, if the UE 115 does not have the capability to encode the SCI 435-a within the duration between LBT 425-a ending time and transmission starting time (e.g., between the end of the LBT 425-a and the beginning of the resource 410-a), then the UE 115 may prepare the SCI 435-a slot by slot. For example, the UE 115 may first prepare the SCI 435-a for a slot n (e.g., the resource 410-a), however, if the LBT 425-a fails at the beginning of slot n, then the UE 115 may prepare the SCI 435-a for slot n+1 (e.g., the resource 410-b).

That is, the UE 115 may first prepare SCI 435 for slot n and if the LBT 425-a passes before slot n, the UE 115 may use this SCI 435 for transmission. However, if the LBT 425-a fails before slot n, then the UE 115 may perform the LBT 425-a in slot n. As such, the UE 115 may not start transmission in slot n and may drop this SCI 435 and prepare a SCI 435-a for slot n+1. If LBT passes before slot n+1, the UE 115 may use the SCI 435-a for transmission. Otherwise, the UE 115 may prepare a subsequent SCI 435 for slot n+2.

In some examples, the UE 115 may select two resources for retransmission of the sidelink message 415 after performing the LBT 425-a. In such examples, the location of second retransmission resource 410 may be harder to be predict as the UE 115 may not have an indication of when the first retransmission of the sidelink message 415 may clear the LBT 425-b. In this case, the location of the second retransmission resource 410 may be up to UE implementation. However, UE 115 may determine the K1 value indicated in SCI 435-b (e.g., first retransmission SCI 435) based on a time gap (e.g., the gap to the second retransmission resource 410) which is already signaled over the air via the SCI 435-a.

That is, the UE 115 may determine the K1 value based on the time gap between the resource 410-e and the resource 410-g, where the K1 value indicating the second resource for HARQ feedback 430-b may be selected such that it is positioned in time between the resource 410-e and the resource 410-g. In this way, the resource for HARQ feedback 430-b may satisfy timing constraints for decoding the first retransmission of the sidelink message 415, sending a NACK via the HARQ feedback 430-b, subsequently monitoring for the second retransmission of the sidelink message 415 via the resource 410-g, and sending feedback (e.g., an ACK or a NACK) before resource 410-g in which a second retransmission of the HARQ feedback 430-b may occur.

For example, prior to performing the LBT 425-a, the UE 115 may perform a resource selection procedure to select the resource 410-b for the initial sidelink message 415 and select one or more candidate resources 410 from available resources of the resource pool 405. Based on performing the resource selection procedure, the UE 115 may perform the LBT 425-a.

If the LBT 425-a is successful, the UE 115 may transmit the initial sidelink message 415 and associated SCI 435-a via the resource 410-b. In such examples, the SCI 435-a may include an indication of the resource for HARQ feedback 430-a, an indication of the resource 410-e (e.g., first retransmission resource), an indication of a resource 410-g (e.g., second retransmission resource), or a combination thereof, where the resource 410-e is selected from the candidate resources 410 based on the K1 value between the time slot of the resource 410-b and the time slot of the resource for HARQ feedback 430-a. Further, UE 115 may select the resource 410-e and the resource 410-g, such that the time gap between the resource 410-b and the resource 410-e satisfies the minimum time gap, and the time gap between the resource 410-e and the resource 410-g also satisfies the minimum time gap.

If the UE 115 receives, via the resource for the HARQ feedback 430-a, a NACK as part of the HARQ feedback 430-a, the UE 115 may perform the LBT 425-b and, if successful, may retransmit the sidelink message 415 via the resource 410-e. Additionally, the UE 115 may also transmit SCI 435-b via the resource 410-e, where the SCI 435-b may be associated with the retransmission of the sidelink message 415. For example, the UE 115 may indicate, via the SCI 435-b, a resource for the HARQ feedback 430-b of the retransmission of the sidelink message 415. In such examples, the UE 115 may determine the resource for the HARQ feedback 430-b based on the time gap between the resource 410-e and the resource 410-g. That is, the K1 value (e.g., time between the resource 410-e and the resource for HARQ feedback 430-b) may be based on the time gap between the two resources 410 (e.g., the resource 410-e and the resource 410-g) selected for retransmission of the sidelink message 415.

If the UE 115 receives, via the resource for the HARQ feedback 430-b, a NACK as part of the HARQ feedback 430-b, the UE 115 may perform the LBT 425-c and, if successful, may perform a second retransmission of the sidelink message 415 via the resource 410-g. In this way, the UE 115 may select and indicate two or more retransmission resources 410 from candidate resources 410 after performing the initial LBT 425-a, thereby enabling the UE 115 to accurately predict the time gaps between transmission and retransmission resources 410 in dynamic HARQ timelines.

In some examples, the UE 115 may reserve resources within 64 slots of a selection window 420 in the resource pool 405 with dynamic HARQ timeline, where the selection window may include resources 410 for the initial transmission of the sidelink message 415 as well as resources that are subsequent to the selected resource for the initial transmission of the sidelink message 415. It is to be understood that the resource pool illustrated in FIG. 4 may include a larger quantity of resources than depicted, such that the UE 115 may select resources from within a selection window 420 of a defined number of time slots, such as 64 time slots. For example, because the dynamic HARQ timeline (e.g., indicating resources for HARQ feedback 430-a after the LBT 425-a) may increase the gap between the PSSCH (e.g., transmission of the sidelink message 415) and associated PSFCH (e.g., reception of the HARQ feedback 430), the UE 115 may not be able to reserve the additional two resources 410 within 32 slots as conventional SCI messages may lack a sufficient quantity of bits for selecting resources over 64 slots. As discussed herein, the quantity of bits may be increased to enable the UE 115 to reserve, within the selection window 420 spanning 64 slots, two resources for two retransmissions of the sidelink message 415. For example, the UE 115 may reserve the resource 410-e and the resource 410-g from the selection window 420.

In such examples, a quantity of bits in the TRIV (e.g., resource reservation field) of the SCI 435-a may be increased based on a value of a quantity of resources reserved (e.g., sl-MaxNumPerReserve) for the sidelink message 415. For example, the quantity of bits for the TRIV may be six bits when the value of the higher layer parameter sl-MaxNumPerReserve is configured to be two. Otherwise, the quantity of bits for the TRIV may be 11 bits when the value of the higher layer parameter sl-MaxNumPerReserve is configured to be three. As such, the UE 115 may determine the TRIV based on the following pseudocode:

```
if N = 1
      TRIV = 0
elseif N = 2
      TRIV = t₁
else
  if (t₂ − t₁ − 1) ≤ 31
    TRIV = 62(t₂ − t₁ − 1) + t₁ + 63
  else
    TRIV = 62(63 − t₂ + t₁) + 126
        − t₁
  end if
end if
```

Where the resource 410-b of the sidelink message 415 may be associated with the slot that the SCI 435-a (e.g., SCI format 1-A) was received at a receiving UE 115, and tᵢ denotes i-th resource 410 time offset that is represented in logical slots of the resource pool 405 with respect to the first resource, where for N=2, 1≤t₁≤63; and for N=3, 1≤t₁≤62, t₁≤t₂≤63.

In such examples as depicted in FIG. 4, the UE 115 may indicate in SCI 435-a a reservation of resource 410-e and the resource 410-g from within the selection window 420 of the resource pool 405 for retransmission of the sidelink message 415 prior to, or after, performing the LBT 425-a. As such, the UE 115 may indicate the reserved resource 410-e and the reserved resource 410-g via the TRIV field in the SCI 435-a, where the UE 115 may determine the TRIV based on the logical offset value N, where N is based on the maximum quantity of reserved resources (e.g., sl-MaxNumPerReserve). In this way, the receiving UE 115 may have an indication of the resource 410-e and the resource 410-g, such that the receiving UE 115 may monitor the occasions of the resource 410-e and the resource 410-g and attempt to receive the retransmissions of the sidelink message 415.

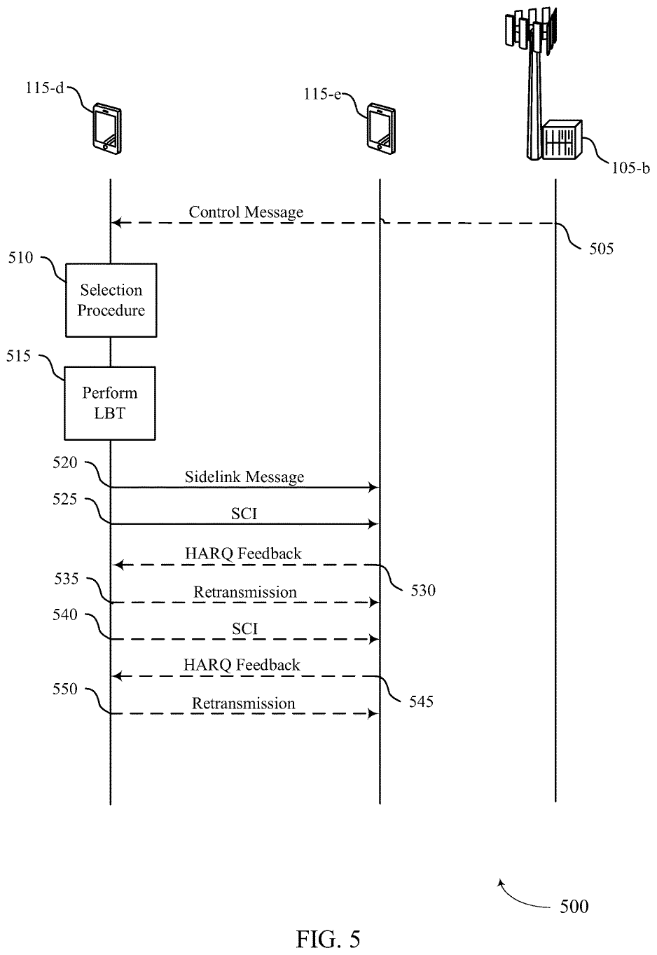

FIG. 5 illustrates an example of a process flow 500 that supports resource selection enhancement in accordance with one or more aspects of the present disclosure. Aspects of the process flow 500 may implement, or be implemented by, the wireless communications system 100, the network architecture 200, the wireless communications system 300, and the timing diagram 400, as described herein with reference to FIGS. 1 through 4. For example, the process flow 500 may include a UE 115-d and a UE 115-e, which may be examples of corresponding UEs 115 as described herein. Further, the process flow 500 may include a network entity 105-b, which may be an example of network entities 105 as described herein.

In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time. The process flow 500 may implement techniques for selecting retransmission resources for sidelink messages after performing an LBT procedure.

At 505, the network entity 105-a may transmit, to the UE 115-d, a control message (e.g., such as control message 310) indicating a resource pool for sidelink communication. In such examples, the UE 115-d and the UE 115-c may be operating in a first sidelink mode of operation. Alternatively, the UE 115-d may autonomously determine a resource pool. In such examples, the UE 115-d and the UE 115-e may be operating in a second sidelink mode of operation.

At 510, the UE 115-d may perform a resource selection procedure to select a resource for transmission (e.g., such as the resource 410-b) of a first sidelink message (e.g., such as a sidelink message 305 or a sidelink message 415). Further, the UE 115-d may select, as part of the resource selection procedure, multiple candidate resources (e.g., such as candidate resources 410) from the resource pool (e.g., such as the resource pool 405).

In some examples, the UE 115-d may select the initial resource (e.g., the resource 410-b) and the candidate resources (e.g., candidate resources 410) from within a selection window (e.g., such as a selection window 420) of the resource pool, where the selection window may span 64 time slots. As such, a quantity of bits in a resource reservation field (e.g., TRIV) of a first SCI associated with reserving resources for one or more retransmissions of a first sidelink message (e.g., such as a sidelink message 415) may be based on a quantity of resources reserved for retransmission of the first sidelink message as described herein with reference to FIG. 4. That is, the UE 115 may reserve up to two resources (e.g., such as the resource 410-e and the resource 410-g) from within a selection window (e.g., such as a selection window 420) that spans 64 time slots of the resource pool. In such cases, the UE 115-c may indicate such resources via the TRIV value of a first SCI (e.g., such as an SCI 435-a). The UE 115-e may perform blind detection to receive the first SCI and receive the indication of such resources.

At 515, the UE 115-d may perform a LBT procedure (e.g., such as the LBT 425-a) to gain access to a sidelink channel (e.g., such as a PSSCH). At 520, the UE 115-d may transmit, based on performing the LBT, the first sidelink message during a first time slot via the resource for transmission (e.g., such as the resource 410-b) of the first sidelink message.

At 525, the UE 115-d may transmit first SCI (e.g., such as the SCI 435-a) associated with the first sidelink message, where the first SCI indicates a resource for transmission of feedback for the first sidelink message (e.g., such as a resource for HARQ feedback 430-a), a first retransmission resource for retransmission of the first sidelink message (e.g., such as the resource 410-e), a second retransmission resource for retransmission of the retransmission of the first sidelink message (e.g., such as the resource 410-g), or a combination thereof. In such examples, the UE 115-d may select the first retransmission resource of the multiple candidate resources (e.g., such as the candidate resources 410) based on a first time gap between (e.g., such as the first K1 value) the first time slot associated with the resource for transmission of the first sidelink message and a time slot of the resource for transmission of the feedback for the first sidelink message in accordance with the techniques described herein with reference to FIG. 4. In such examples, UE 115-d may select the first and second retransmission resources after successful performance of the LBT at 515.

In some examples, the UE 115-d may drop second SCI based on a second LBT procedure indicating that the sidelink channel is unavailable during a second time slot that occurs prior to the first time slot. In such examples, the UE 115-d may generate the first SCI based on LBT procedure at 515 indicating that the sidelink channel is available during the first time slot.

The UE 115-e may receive the first SCI via a PSCCH and monitor the resource for the first sidelink message. As such, at 530, the UE 115-d may receive, via the resource for feedback of the first sidelink message, a NACK as part of HARQ feedback (e.g., such as the HARQ feedback 430-a) from the UE 115-e.

At 535, the UE 115-d may retransmit the first sidelink message via the first retransmission resources. At 540, the UE 115-d may also transmit second SCI (e.g., such as SCI 435-b) associated with the retransmission of the first sidelink message. The UE 115-d may indicate, via the second SCI, a second resource for feedback for the retransmission of the first sidelink message (e.g., such as the resource for HARQ feedback 430-b), where the second resource for feedback for the retransmission of the first sidelink message is based on a second time gap (e.g., such as the second K1 value) between a time slot associated with the first retransmission resource and the time slot of the second retransmission resource for retransmission of the first sidelink message as described herein with reference to FIG. 4.

The UE 115-e may receive the second SCI via the PSCCH and monitor the first retransmission resource for the retransmission of the first sidelink message. At 545, the UE 115-d may receive, via the second resource for feedback, a NACK as part of the HARQ feedback. As such, at 550, the UE 115-d may retransmit the first sidelink message for a second time via the second retransmission resource.

In this way, the UE 115-d may efficiently select resources for retransmission of sidelink message in accordance with the minimum time gap in dynamic HARQ timelines, leading to reduced latency and improved coordination between devices.

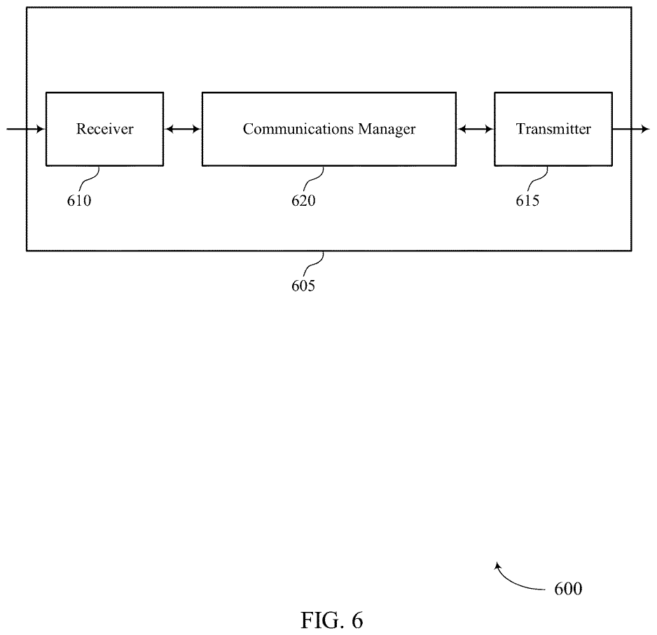

FIG. 6 illustrates a block diagram 600 of a device 605 that supports resource selection enhancement in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to resource selection enhancement). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource selection enhancement). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of resource selection enhancement as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for transmitting or receiving a control message indicating a resource pool for sidelink communication. The communications manager 620 may be configured as or otherwise support a means for performing a resource selection procedure to select a resource for transmission of a first sidelink message and a set of multiple candidate resources from the resource pool, the set of multiple candidate resources being candidates for retransmission of the first sidelink message. The communications manager 620 may be configured as or otherwise support a means for transmitting, based on performing a LBT procedure to gain access to a sidelink channel of the resource pool, the first sidelink message during a first time slot via the resource for transmission of the first sidelink message. The communications manager 620 may be configured as or otherwise support a means for transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

Additionally, or alternatively, the communications manager 620 may support wireless communications at a UE in accordance with examples as disclosed herein. For example, the communications manager 620 may be configured as or otherwise support a means for transmitting or receiving a control message indicating a resource pool for sidelink communication. The communications manager 620 may be configured as or otherwise support a means for receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message. The communications manager 620 may be configured as or otherwise support a means for monitoring, based on the SCI, for the first sidelink message during the first time slot via the resource for transmission of the first sidelink message.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for selecting resources for sidelink messages from multiple candidate resources after performing a LBT procedure, which may result in more efficient utilization of communication resources.

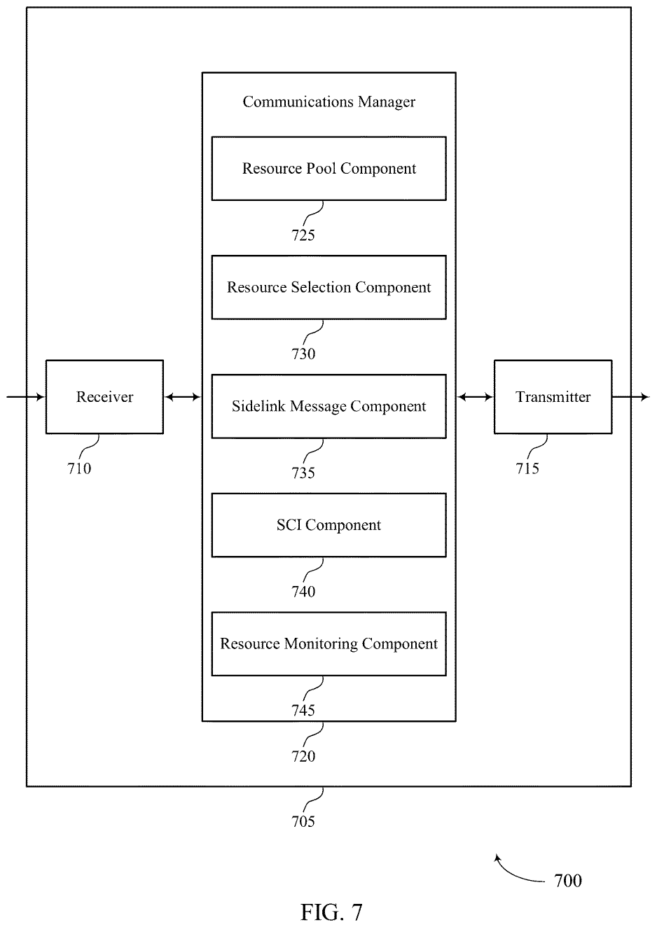

FIG. 7 illustrates a block diagram 700 of a device 705 that supports resource selection enhancement in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to resource selection enhancement). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource selection enhancement). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of resource selection enhancement as described herein. For example, the communications manager 720 may include a resource pool component 725, a resource selection component 730, a sidelink message component 735, an SCI component 740, a resource monitoring component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The resource pool component 725 may be configured as or otherwise support a means for transmitting or receiving a control message indicating a resource pool for sidelink communication. The resource selection component 730 may be configured as or otherwise support a means for performing a resource selection procedure to select a resource for transmission of a first sidelink message and a set of multiple candidate resources from the resource pool, the set of multiple candidate resources being candidates for retransmission of the first sidelink message. The sidelink message component 735 may be configured as or otherwise support a means for transmitting, based on performing a LBT procedure to gain access to a sidelink channel of the resource pool, the first sidelink message during a first time slot via the resource for transmission of the first sidelink message. The SCI component 740 may be configured as or otherwise support a means for transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

Additionally, or alternatively, the communications manager 720 may support wireless communications at a UE in accordance with examples as disclosed herein. The resource pool component 725 may be configured as or otherwise support a means for transmitting or receiving a control message indicating a resource pool for sidelink communication. The SCI component 740 may be configured as or otherwise support a means for receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message. The resource monitoring component 745 may be configured as or otherwise support a means for monitoring, based on the SCI, for the first sidelink message during the first time slot via the resource for transmission of the first sidelink message.

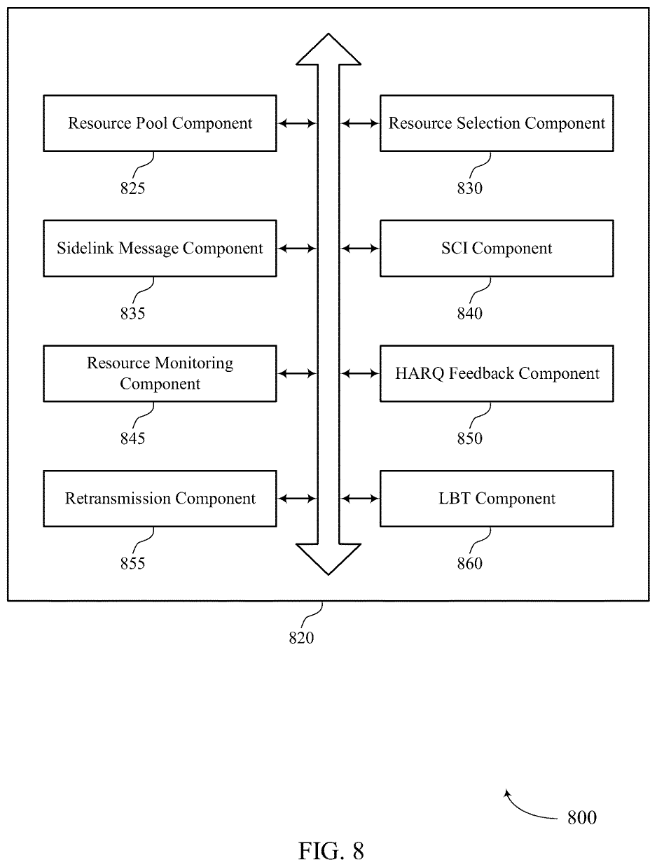

FIG. 8 illustrates a block diagram 800 of a communications manager 820 that supports resource selection enhancement in accordance with one or more aspects of the present disclosure. The communications manager 820 may be an example of aspects of a communications manager 620, a communications manager 720, or both, as described herein. The communications manager 820, or various components thereof, may be an example of means for performing various aspects of resource selection enhancement as described herein. For example, the communications manager 820 may include a resource pool component 825, a resource selection component 830, a sidelink message component 835, an SCI component 840, a resource monitoring component 845, an HARQ feedback component 850, a retransmission component 855, an LBT component 860, or any combination thereof. Each of these components may communicate, directly or indirectly, with one another (e.g., via one or more buses).

The communications manager 820 may support wireless communications at a UE in accordance with examples as disclosed herein. The resource pool component 825 may be configured as or otherwise support a means for transmitting or receiving a control message indicating a resource pool for sidelink communication. The resource selection component 830 may be configured as or otherwise support a means for performing a resource selection procedure to select a resource for transmission of a first sidelink message and a set of multiple candidate resources from the resource pool, the set of multiple candidate resources being candidates for retransmission of the first sidelink message. The sidelink message component 835 may be configured as or otherwise support a means for transmitting, based on performing a LBT procedure to gain access to a sidelink channel of the resource pool, the first sidelink message during a first time slot via the resource for transmission of the first sidelink message. The SCI component 840 may be configured as or otherwise support a means for transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

In some examples, the HARQ feedback component 850 may be configured as or otherwise support a means for receiving a negative acknowledgment via the resource for transmission of the feedback of the first sidelink message. In some examples, the retransmission component 855 may be configured as or otherwise support a means for transmitting, via the first retransmission resource, a retransmission of the first sidelink message and second SCI.

In some examples, the first SCI indicates a slot of a second retransmission resource for retransmission of the first sidelink message. In some examples, the second SCI indicates a second resource for feedback for the retransmission of the first sidelink message, the second resource for feedback for the retransmission of the first sidelink message being based on a second time gap between a time slot associated with the first retransmission resource and the time slot of the second retransmission resource for retransmission of the first sidelink message.

In some examples, to support transmitting the first SCI, the SCI component 840 may be configured as or otherwise support a means for transmitting, via the first SCI, an indication of a second retransmission resource for a second retransmission of the first sidelink message, the second retransmission resource being different from the first retransmission resource.

In some examples, the first retransmission resource and the second retransmission resource are selected after performing the LBT procedure.

In some examples, the first SCI is transmitted in the first time slot based on the LBT procedure indicating that the sidelink channel is available prior to the first time slot.

In some examples, the LBT component 860 may be configured as or otherwise support a means for dropping second SCI based on the LBT procedure indicating that the sidelink channel is unavailable during a second time slot that occurs prior to the first time slot. In some examples, the SCI component 840 may be configured as or otherwise support a means for generating the first SCI based on the LBT procedure indicating that the sidelink channel is available during the first time slot.

In some examples, the resource selection procedure corresponds to resource selection within a time duration of sixty-four slots.

In some examples, a quantity of bits in a resource reservation field of the first SCI associated with reserving resources for one or more retransmissions of the first sidelink message is based on a quantity of resources reserved for retransmission of the first sidelink message.

Additionally, or alternatively, the communications manager 820 may support wireless communications at a UE in accordance with examples as disclosed herein. In some examples, the resource pool component 825 may be configured as or otherwise support a means for transmitting or receiving a control message indicating a resource pool for sidelink communication. In some examples, the SCI component 840 may be configured as or otherwise support a means for receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message. The resource monitoring component 845 may be configured as or otherwise support a means for monitoring, based on the SCI, for the first sidelink message during the first time slot via the resource for transmission of the first sidelink message.

In some examples, the HARQ feedback component 850 may be configured as or otherwise support a means for transmitting a negative acknowledgment via the resource for transmission of the feedback of the first sidelink message. In some examples, the retransmission component 855 may be configured as or otherwise support a means for receiving, via the first retransmission resource, a retransmission of the first sidelink message and second SCI.

In some examples, the SCI indicates a slot of a second retransmission resource for retransmission of the first sidelink message. In some examples, the second SCI indicates a second resource for feedback for the retransmission of the first sidelink message, the second resource for feedback for the retransmission of the first sidelink message being based on a second time gap between a time slot associated with the first retransmission resource and the time slot of the second retransmission resource for retransmission of the first sidelink message.

In some examples, to support receiving the SCI, the SCI component 840 may be configured as or otherwise support a means for receiving, via the SCI, an indication of a second retransmission resource for a second retransmission of the first sidelink message, the second retransmission resource being different from the first retransmission resource.

In some examples, the SCI is received in the first time slot.

In some examples, the set of multiple candidate resources are within a time duration of sixty-four slots.

In some examples, a quantity of bits in a resource reservation field of the SCI associated with reserving resources for one or more retransmissions of the first sidelink message is based on a quantity of resources reserved for retransmission of the first sidelink message.

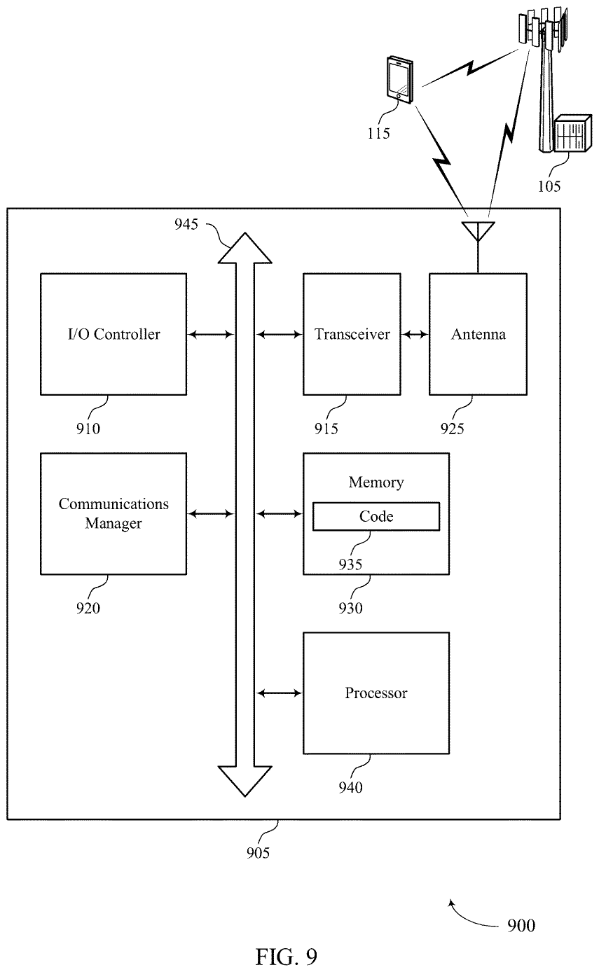

FIG. 9 illustrates a diagram of a system 900 including a device 905 that supports resource selection enhancement in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROIDR, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting resource selection enhancement). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for transmitting or receiving a control message indicating a resource pool for sidelink communication. The communications manager 920 may be configured as or otherwise support a means for performing a resource selection procedure to select a resource for transmission of a first sidelink message and a set of multiple candidate resources from the resource pool, the set of multiple candidate resources being candidates for retransmission of the first sidelink message. The communications manager 920 may be configured as or otherwise support a means for transmitting, based on performing a LBT procedure to gain access to a sidelink channel of the resource pool, the first sidelink message during a first time slot via the resource for transmission of the first sidelink message. The communications manager 920 may be configured as or otherwise support a means for transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message.

Additionally, or alternatively, the communications manager 920 may support wireless communications at a UE in accordance with examples as disclosed herein. For example, the communications manager 920 may be configured as or otherwise support a means for transmitting or receiving a control message indicating a resource pool for sidelink communication. The communications manager 920 may be configured as or otherwise support a means for receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message. The communications manager 920 may be configured as or otherwise support a means for monitoring, based on the SCI, for the first sidelink message during the first time slot via the resource for transmission of the first sidelink message.

By including or configuring the communications manager 920 in accordance with examples as described herein, the device 905 may support techniques for selecting resources for sidelink messages from multiple candidate resources after performing a LBT procedure, which may result in improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of resource selection enhancement as described herein, or the processor 940 and the memory 930 may be otherwise configured to perform or support such operations.

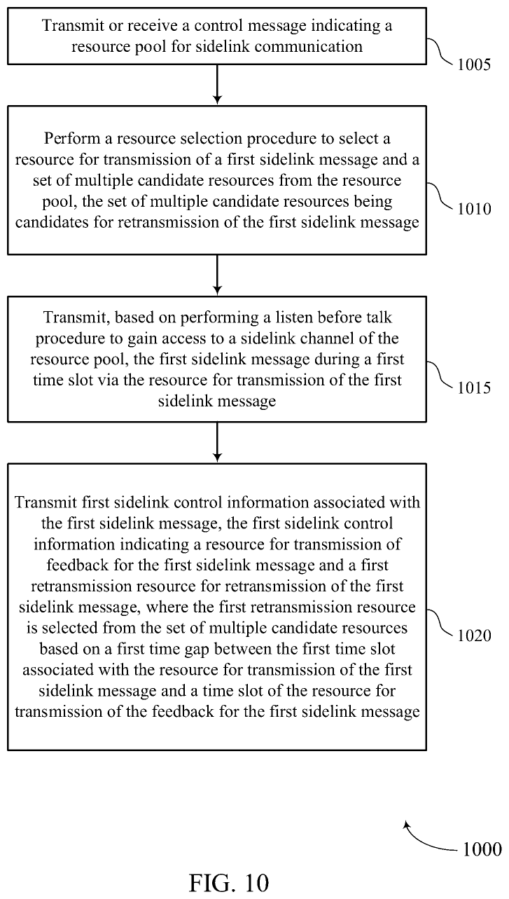

FIG. 10 illustrates a flowchart showing a method 1000 that supports resource selection enhancement in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include transmitting or receiving a control message indicating a resource pool for sidelink communication. The operations of 1005 may be performed in accordance with examples as disclosed herein. In some examples, aspects of the operations of 1005 may be performed by a resource pool component 825 as described with reference to FIG. 8.

At 1010, the method may include performing a resource selection procedure to select a resource for transmission of a first sidelink message and a set of multiple candidate resources from the resource pool, the set of multiple candidate resources being candidates for retransmission of the first sidelink message. The operations of 1010 may be performed in accordance with examples as disclosed herein. In some examples, aspects of the operations of 1010 may be performed by a resource selection component 830 as described with reference to FIG. 8.

At 1015, the method may include transmitting, based on performing a LBT procedure to gain access to a sidelink channel of the resource pool, the first sidelink message during a first time slot via the resource for transmission of the first sidelink message. The operations of 1015 may be performed in accordance with examples as disclosed herein. In some examples, aspects of the operations of 1015 may be performed by a sidelink message component 835 as described with reference to FIG. 8.

At 1020, the method may include transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message. The operations of 1020 may be performed in accordance with examples as disclosed herein. In some examples, aspects of the operations of 1020 may be performed by an SCI component 840 as described with reference to FIG. 8.

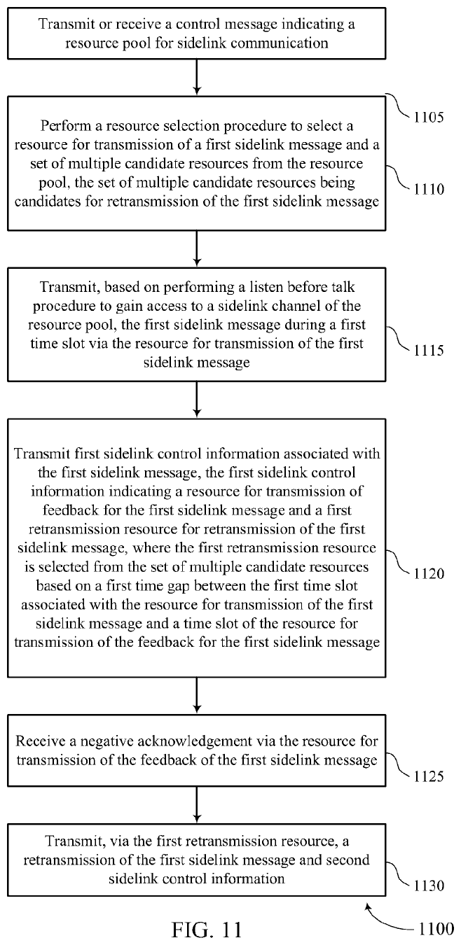

FIG. 11 illustrates a flowchart showing a method 1100 that supports resource selection enhancement in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting or receiving a control message indicating a resource pool for sidelink communication. The operations of 1105 may be performed in accordance with examples as disclosed herein. In some examples, aspects of the operations of 1105 may be performed by a resource pool component 825 as described with reference to FIG. 8.

At 1110, the method may include performing a resource selection procedure to select a resource for transmission of a first sidelink message and a set of multiple candidate resources from the resource pool, the set of multiple candidate resources being candidates for retransmission of the first sidelink message. The operations of 1110 may be performed in accordance with examples as disclosed herein. In some examples, aspects of the operations of 1110 may be performed by a resource selection component 830 as described with reference to FIG. 8.

At 1115, the method may include transmitting, based on performing a LBT procedure to gain access to a sidelink channel of the resource pool, the first sidelink message during a first time slot via the resource for transmission of the first sidelink message. The operations of 1115 may be performed in accordance with examples as disclosed herein. In some examples, aspects of the operations of 1115 may be performed by a sidelink message component 835 as described with reference to FIG. 8.

At 1120, the method may include transmitting first SCI associated with the first sidelink message, the first SCI indicating a resource for transmission of feedback for the first sidelink message and a first retransmission resource for retransmission of the first sidelink message, where the first retransmission resource is selected from the set of multiple candidate resources based on a first time gap between the first time slot associated with the resource for transmission of the first sidelink message and a time slot of the resource for transmission of the feedback for the first sidelink message. The operations of 1120 may be performed in accordance with examples as disclosed herein. In some examples, aspects of the operations of 1120 may be performed by an SCI component 840 as described with reference to FIG. 8.

At 1125, the method may include receiving a negative acknowledgment via the resource for transmission of the feedback of the first sidelink message. The operations of 1125 may be performed in accordance with examples as disclosed herein. In some examples, aspects of the operations of 1125 may be performed by an HARQ feedback component 850 as described with reference to FIG. 8.

At 1130, the method may include transmitting, via the first retransmission resource, a retransmission of the first sidelink message and second SCI. The operations of 1130 may be performed in accordance with examples as disclosed herein. In some examples, aspects of the operations of 1130 may be performed by a retransmission component 855 as described with reference to FIG. 8.

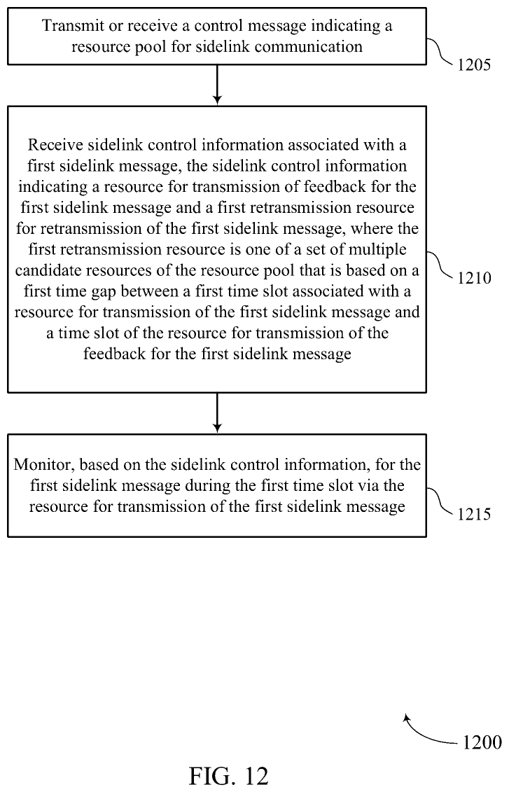

FIG. 12 illustrates a flowchart showing a method 1200 that supports resource selection enhancement in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include transmitting or receiving a control message indicating a resource pool for sidelink communication. The operations of 1205 may be performed in accordance with examples as disclosed herein. In some examples, aspects of the operations of 1205 may be performed by a resource pool component 825 as described with reference to FIG. 8.

At 1210, the method may include receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message. The operations of 1210 may be performed in accordance with examples as disclosed herein. In some examples, aspects of the operations of 1210 may be performed by an SCI component 840 as described with reference to FIG. 8.

At 1215, the method may include monitoring, based on the SCI, for the first sidelink message during the first time slot via the resource for transmission of the first sidelink message. The operations of 1215 may be performed in accordance with examples as disclosed herein. In some examples, aspects of the operations of 1215 may be performed by a resource monitoring component 845 as described with reference to FIG. 8.

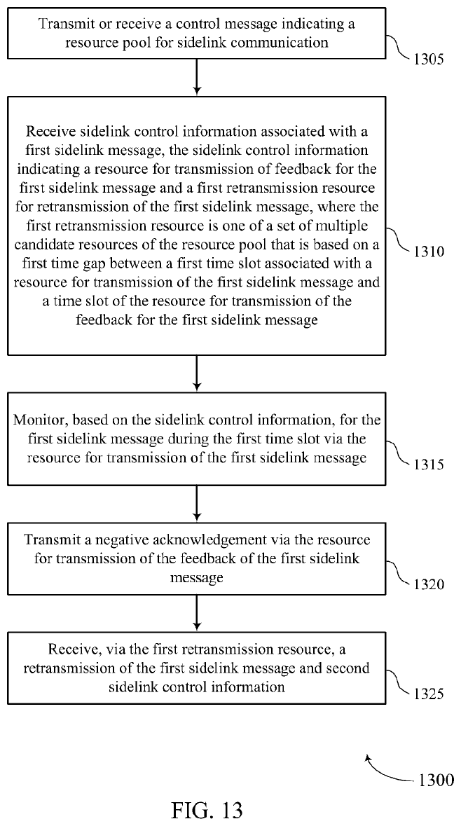

FIG. 13 illustrates a flowchart showing a method 1300 that supports resource selection enhancement in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include transmitting or receiving a control message indicating a resource pool for sidelink communication. The operations of 1305 may be performed in accordance with examples as disclosed herein. In some examples, aspects of the operations of 1305 may be performed by a resource pool component 825 as described with reference to FIG. 8.

At 1310, the method may include receiving SCI associated with a first sidelink message, the SCI indicating a resource for transmission of feedback for the first sidelink message and a first retransmission resource for retransmission of the first sidelink message, where the first retransmission resource is one of a set of multiple candidate resources of the resource pool that is based on a first time gap between a first time slot associated with a resource for transmission of the first sidelink message and a time slot of the resource for transmission of the feedback for the first sidelink message. The operations of 1310 may be performed in accordance with examples as disclosed herein. In some examples, aspects of the operations of 1310 may be performed by an SCI component 840 as described with reference to FIG. 8.

At 1315, the method may include monitoring, based on the SCI, for the first sidelink message during the first time slot via the resource for transmission of the first sidelink message. The operations of 1315 may be performed in accordance with examples as disclosed herein. In some examples, aspects of the operations of 1315 may be performed by a resource monitoring component 845 as described with reference to FIG. 8.

At 1320, the method may include transmitting a negative acknowledgment via the resource for transmission of the feedback of the first sidelink message. The operations of 1320 may be performed in accordance with examples as disclosed herein. In some examples, aspects of the operations of 1320 may be performed by an HARQ feedback component 850 as described with reference to FIG. 8.

At 1325, the method may include receiving, via the first retransmission resource, a retransmission of the first sidelink message and second SCI. The operations of 1325 may be performed in accordance with examples as disclosed herein. In some examples, aspects of the operations of 1325 may be performed by a retransmission component 855 as described with reference to FIG. 8.

The following provides an overview of aspects of the present disclosure:

Aspect 1: A method for wireless communications at a UE, comprising: transmitting or receiving a control message indicating a resource pool for sidelink communication; performing a resource selection procedure to select a resource for transmission of a first sidelink message and a plurality of candidate resources from the resource pool, the plurality of candidate resources being candidates for retransmission of the first sidelink message; transmitting, based at least in part on performing a LBT procedure to gain access to a sidelink channel of the resource pool, the first sidelink message during a first time slot via the resource for transmission of the first sidelink message; and transmitting first SCI associated with the first sidelink message, the first SCI indicating a resource for transmission of feedback for the first sidelink message and a first retransmission resource for retransmission of the first sidelink message, wherein the first retransmission resource is selected from the plurality of candidate resources based at least in part on a first time gap between the first time slot associated with the resource for transmission of the first sidelink message and a time slot of the resource for transmission of the feedback for the first sidelink message.

Aspect 2: The method of aspect 1, further comprising: receiving a NACK via the resource for transmission of the feedback of the first sidelink message; and transmitting, via the first retransmission resource, a retransmission of the first sidelink message and second SCI.

Aspect 3: The method of aspect 2, wherein the first SCI indicates a slot of a second retransmission resource for retransmission of the first sidelink message, and the second SCI indicates a second resource for feedback for the retransmission of the first sidelink message, the second resource for feedback for the retransmission of the first sidelink message being based at least in part on a second time gap between a time slot associated with the first retransmission resource and the time slot of the second retransmission resource for retransmission of the first sidelink message.

Aspect 4: The method of any of aspects 1 through 3, wherein transmitting the first SCI comprises: transmitting, via the first SCI, an indication of a second retransmission resource for a second retransmission of the first sidelink message, the second retransmission resource being different from the first retransmission resource.

Aspect 5: The method of aspect 4, wherein the first retransmission resource and the second retransmission resource are selected after performing the LBT procedure.

Aspect 6: The method of any of aspects 1 through 5, wherein the first SCI is transmitted in the first time slot based at least in part on the LBT procedure indicating that the sidelink channel is available prior to the first time slot.

Aspect 7: The method of any of aspects 1 through 6, further comprising: dropping second SCI based at least in part on the LBT procedure indicating that the sidelink channel is unavailable during a second time slot that occurs prior to the first time slot; and generating the first SCI based at least in part on the LBT procedure indicating that the sidelink channel is available during the first time slot.

Aspect 8: The method of any of aspects 1 through 7, wherein the resource selection procedure corresponds to resource selection within a time duration of sixty-four slots.

Aspect 9: The method of aspect 8, wherein a quantity of bits in a resource reservation field of the first SCI associated with reserving resources for one or more retransmissions of the first sidelink message is based at least in part on a quantity of resources reserved for retransmission of the first sidelink message.

Aspect 10: A method for wireless communications at a UE, comprising: transmitting or receiving a control message indicating a resource pool for sidelink communication; receiving SCI associated with a first sidelink message, the SCI indicating a resource for transmission of feedback for the first sidelink message and a first retransmission resource for retransmission of the first sidelink message, wherein the first retransmission resource is one of a plurality of candidate resources of the resource pool that is based at least in part on a first time gap between a first time slot associated with a resource for transmission of the first sidelink message and a time slot of the resource for transmission of the feedback for the first sidelink message; and monitoring, based at least in part on the SCI, for the first sidelink message during the first time slot via the resource for transmission of the first sidelink message.

Aspect 11: The method of aspect 10, further comprising: transmitting a NACK via the resource for transmission of the feedback of the first sidelink message; and receiving, via the first retransmission resource, a retransmission of the first sidelink message and second SCI.

Aspect 12: The method of aspect 11, wherein the SCI indicates a slot of a second retransmission resource for retransmission of the first sidelink message, and the second SCI indicates a second resource for feedback for the retransmission of the first sidelink message, the second resource for feedback for the retransmission of the first sidelink message being based at least in part on a second time gap between a time slot associated with the first retransmission resource and the time slot of the second retransmission resource for retransmission of the first sidelink message.

Aspect 13: The method of any of aspects 10 through 12, wherein receiving the SCI comprises: receiving, via the SCI, an indication of a second retransmission resource for a second retransmission of the first sidelink message, the second retransmission resource being different from the first retransmission resource.

Aspect 14: The method of any of aspects 10 through 13, wherein the SCI is received in the first time slot.

Aspect 15: The method of any of aspects 10 through 14, wherein the plurality of candidate resources are within a time duration of sixty-four slots.

Aspect 16: The method of aspect 15, wherein a quantity of bits in a resource reservation field of the SCI associated with reserving resources for one or more retransmissions of the first sidelink message is based at least in part on a quantity of resources reserved for retransmission of the first sidelink message.

Aspect 17: An apparatus for wireless communications at a UE, comprising a processor; memory coupled with the processor; and instructions stored in the memory and executable by the processor to cause the apparatus to perform a method of any of aspects 1 through 9.

Aspect 18: An apparatus for wireless communications at a UE, comprising at least one means for performing a method of any of aspects 1 through 9.

Aspect 19: A non-transitory computer-readable medium storing code for wireless communications at a UE, the code comprising instructions executable by a processor to perform a method of any of aspects 1 through 9.

Aspect 20: An apparatus for wireless communications at a UE, comprising a processor; memory coupled with the processor; and instructions stored in the memory and executable by the processor to cause the apparatus to perform a method of any of aspects 10 through 16.

Aspect 21: An apparatus for wireless communications at a UE, comprising at least one means for performing a method of any of aspects 10 through 16.

Aspect 22: A non-transitory computer-readable medium storing code for wireless communications at a UE, the code comprising instructions executable by a processor to perform a method of any of aspects 10 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
transmit or receive a control message indicating a resource pool for sidelink communication;
perform a resource selection procedure to select a resource for transmission of a first sidelink message and a plurality of candidate resources from the resource pool, the plurality of candidate resources being candidates for retransmission of the first sidelink message;
transmit, based at least in part on performing a listen before talk procedure to gain access to a sidelink channel of the resource pool, the first sidelink message during a first time slot via the resource for transmission of the first sidelink message; and
transmit first sidelink control information associated with the first sidelink message, the first sidelink control information indicating a resource for transmission of feedback for the first sidelink message and a first retransmission resource for retransmission of the first sidelink message, wherein the first retransmission resource is selected from the plurality of candidate resources based at least in part on a first time gap between the first time slot associated with the resource for transmission of the first sidelink message and a time slot of the resource for transmission of the feedback for the first sidelink message.

2. The apparatus of claim 1, wherein the instructions are further executable by the processor to cause the apparatus to:
receive a negative acknowledgment via the resource for transmission of the feedback of the first sidelink message; and
transmit, via the first retransmission resource, a retransmission of the first sidelink message and second sidelink control information.

3. The apparatus of claim 2, wherein the first sidelink control information indicates a slot of a second retransmission resource for retransmission of the first sidelink message, and the second sidelink control information indicates a second resource for feedback for the retransmission of the first sidelink message, the second resource for feedback for the retransmission of the first sidelink message being based at least in part on a second time gap between a time slot associated with the first retransmission resource and the time slot of the second retransmission resource for retransmission of the first sidelink message.

4. The apparatus of claim 1, wherein the instructions to transmit the first sidelink control information are executable by the processor to cause the apparatus to:
transmit, via the first sidelink control information, an indication of a second retransmission resource for a second retransmission of the first sidelink message, the second retransmission resource being different from the first retransmission resource.

5. The apparatus of claim 4, wherein the first retransmission resource and the second retransmission resource are selected after performing the listen before talk procedure.

6. The apparatus of claim 1, wherein the first sidelink control information is transmitted in the first time slot based at least in part on the listen before talk procedure indicating that the sidelink channel is available prior to the first time slot.

7. The apparatus of claim 1, wherein the instructions are further executable by the processor to cause the apparatus to:
drop second sidelink control information based at least in part on the listen before talk procedure indicating that the sidelink channel is unavailable during a second time slot that occurs prior to the first time slot; and
generate the first sidelink control information based at least in part on the listen before talk procedure indicating that the sidelink channel is available during the first time slot.

8. The apparatus of claim 1, wherein the resource selection procedure corresponds to resource selection within a time duration of sixty-four slots.

9. The apparatus of claim 8, wherein a quantity of bits in a resource reservation field of the first sidelink control information associated with reserving resources for one or more retransmissions of the first sidelink message is based at least in part on a quantity of resources reserved for retransmission of the first sidelink message.

10. An apparatus for wireless communications at a user equipment (UE), comprising:
a processor;
memory coupled with the processor; and
instructions stored in the memory and executable by the processor to cause the apparatus to:
transmit or receive a control message indicating a resource pool for sidelink communication;
receive sidelink control information associated with a first sidelink message, the sidelink control information indicating a resource for transmission of feedback for the first sidelink message and a first retransmission resource for retransmission of the first sidelink message, wherein the first retransmission resource is one of a plurality of candidate resources of the resource pool that is based at least in part on a first time gap between a first time slot associated with a resource for transmission of the first sidelink message and a time slot of the resource for transmission of the feedback for the first sidelink message; and
monitor, based at least in part on the sidelink control information, for the first sidelink message during the first time slot via the resource for transmission of the first sidelink message.

11. The apparatus of claim 10, wherein the instructions are further executable by the processor to cause the apparatus to:
transmit a negative acknowledgment via the resource for transmission of the feedback of the first sidelink message; and
receive, via the first retransmission resource, a retransmission of the first sidelink message and second sidelink control information.

12. The apparatus of claim 11, wherein the sidelink control information indicates a slot of a second retransmission resource for retransmission of the first sidelink message, and the second sidelink control information indicates a second resource for feedback for the retransmission of the first sidelink message, the second resource for feedback for the retransmission of the first sidelink message being based at least in part on a second time gap between a time slot associated with the first retransmission resource and the time slot of the second retransmission resource for retransmission of the first sidelink message.

13. The apparatus of claim 10, wherein the instructions to receive the sidelink control information are executable by the processor to cause the apparatus to:
receive, via the sidelink control information, an indication of a second retransmission resource for a second retransmission of the first sidelink message, the second retransmission resource being different from the first retransmission resource.

14. The apparatus of claim 10, wherein the sidelink control information is received in the first time slot.

15. The apparatus of claim 10, wherein the plurality of candidate resources are within a time duration of sixty-four slots.

16. The apparatus of claim 15, wherein a quantity of bits in a resource reservation field of the sidelink control information associated with reserving resources for one or more retransmissions of the first sidelink message is based at least in part on a quantity of resources reserved for retransmission of the first sidelink message.

17. A method for wireless communications at a user equipment (UE), comprising:
transmitting or receiving a control message indicating a resource pool for sidelink communication;
performing a resource selection procedure to select a resource for transmission of a first sidelink message and a plurality of candidate resources from the resource pool, the plurality of candidate resources being candidates for retransmission of the first sidelink message;
transmitting, based at least in part on performing a listen before talk procedure to gain access to a sidelink channel of the resource pool, the first sidelink message during a first time slot via the resource for transmission of the first sidelink message; and
transmitting first sidelink control information associated with the first sidelink message, the first sidelink control information indicating a resource for transmission of feedback for the first sidelink message and a first retransmission resource for retransmission of the first sidelink message, wherein the first retransmission resource is selected from the plurality of candidate resources based at least in part on a first time gap between the first time slot associated with the resource for transmission of the first sidelink message and a time slot of the resource for transmission of the feedback for the first sidelink message.

18. The method of claim 17, further comprising:
receiving a negative acknowledgment via the resource for transmission of the feedback of the first sidelink message; and
transmitting, via the first retransmission resource, a retransmission of the first sidelink message and second sidelink control information.

19. The method of claim 18, wherein the first sidelink control information indicates a slot of a second retransmission resource for retransmission of the first sidelink message, and the second sidelink control information indicates a second resource for feedback for the retransmission of the first sidelink message, the second resource for feedback for the retransmission of the first sidelink message being based at least in part on a second time gap between a time slot associated with the first retransmission resource and the time slot of the second retransmission resource for retransmission of the first sidelink message.

20. The method of claim 17, wherein transmitting the first sidelink control information comprises:
transmitting, via the first sidelink control information, an indication of a second retransmission resource for a second retransmission of the first sidelink message, the second retransmission resource being different from the first retransmission resource.

21.-30. (canceled)
